(19) United States
(12) Patent Application Publication
(10) Pub. No.: US 2009/0158973 A1
(43) Pub. Date: Jun. 25, 2009

(54) MULTI-FUNCTIONAL ARTICLES OF FURNITURE

(75) Inventor: GLENN FELTERMAN, Ft. Smith, AR (US)

Correspondence Address: GILBRETH & ASSOCIATES, P.C., PO BOX 2428, BELLAIRE, TX, 77402-2428, US

(73) Assignee: Riverside Furniture Corporation, Fort Smith, AR (US)

(21) Appl. No.: 11/960,227

(22) Filed: Dec. 19, 2007

(51) Int. Cl. A47B 45/00; A47B 57/00; A47B 88/04; A47B 13/00; B60B 33/00

(52) U.S. Cl. 108/102; 108/59; 16/18 R; 312/223.6; 312/330.1; 312/294

(57) ABSTRACT

Multi-purpose articles of furniture suitable for use as at least a table, a computer workstation, and a design element. Articles comprise a top surface supported by a base, the top surface comprising at least one section fixed in position relative to the base and at least one section movable to many positions. Articles provide organization and storage for a computer, computer-related items and supplies, and may comprise any combination of any one or more the following: storage compartments, shelves, doors, drawers, electrical power outlets, communication ports, and data ports.

### BACKGROUND

1. Technical Field

The present disclosure relates generally to furniture, and more particularly to multipurpose furniture, and even more particularly to multipurpose furniture suitable for use at least as a table, and a computer work station.

2. Background Information

The advances in computer technology have enabled the development of lightweight, portable, compact computers. Portable laptop computers are especially sought after and enjoyed because of the flexibility and mobility they provide. Portable laptop computers can be used virtually anywhere and thus the traditional office and/or computer desk are not required for use with a laptop computer.

A variety of computer desks are known in the art. While a conventional computer desk may provide a user with space for computer peripherals, and/or organization and/or storage of supplies and other computer and office-related items, most laptop users do not wish to be restricted to sitting at a conventional desk in a office, whether a business office or home office, in order to use a laptop computer. While a desk may of course be placed anywhere in an office and/or a home in order to provide a computer work station, many users prefer to not have a desk in the living areas of their office and/or home either due to space constraints and/or aesthetic reasons.

Users of portable computers often position themselves on a chair, loveseat, couch or similar near a table, such as a cocktail/coffee table, end table, or similar, making use of the table as a computer workstation. However, conventional tables do not provide for organization and/or storage of computer-related items, peripherals, and/or supplies. In addition, due to the height and/or positioning of such tables relative to the user, the tables generally do not provide flexibility with respect to positioning of the tabletop, nor do they provide an ergonomic workstation.

In spite of advancements in the art, workstation furniture that is multi-functional and also serves an aesthetic purpose has not been described. Thus, there is a need in the art for articles of furniture that function at least as a table, a workstation, and may serve as a design element.

There is another need in the art for articles of furniture that accommodate, store and/or organize portable computers, and work and/or computer related items and supplies.

These and other needs in the art will become apparent to those of skill in the art upon review of this specification, including its drawings and claims.

### SUMMARY

The following presents a general summary of some of the many possible embodiments of this disclosure in order to provide a basic understanding of this disclosure. This summary is not an extensive overview of all embodiments of the disclosure. This summary is not intended to identify key or critical elements of the disclosure or to delineate or otherwise limit the scope of the claims. The following summary merely presents some concepts of the disclosure in a general form as a prelude to the more detailed description that follows.

According to one non-limiting embodiment there is provided an apparatus comprising a tabletop and a base, wherein the tabletop and the base define an interior compartment, and wherein the tabletop is positioned in a horizontal plane and supported by the base. Generally the tabletop comprises at least first and second tabletop sections positioned adjacent one another, wherein the first tabletop section is immobile with respect to the base, and the second tabletop section is movable with respect to the base, and wherein the second tabletop section is movable within said horizontal plane.

According to another non-limiting embodiment there is provided an apparatus comprising a tabletop and a base, wherein the tabletop and the base define an interior compartment, and wherein the tabletop is supported by the base. Generally the tabletop comprises at least first and second tabletop sections positioned adjacent one another, wherein the first tabletop section is immobile with respect to said base, and the second tabletop section is movable with respect to the base, and wherein the second tabletop section is movable by raising the section away from the base.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIGS. 1A through 1D show, respectively, top, back, end and front views of a non-limiting table of the disclosure.

FIG. 2 provides a cross sectional front elevation view of a non-limiting table of the disclosure.

FIG. 3 provides a cross sectional left-hand end view of a non-limiting table of the disclosure.

FIG. 4 provides a cross sectional right-hand end view of a non-limiting table of the disclosure.

FIG. 5 provides a cross sectional right-hand end view of a non-limiting table of the disclosure with a retractable work surface in an extended position.

FIG. 6 provides a cross sectional plan view of a non-limiting table of the disclosure.

FIG. 7 provides a cross sectional view of a non-limiting storage tray of a table of the disclosure.

FIG. 8 provides a cross sectional right-hand end view of a non-limiting table of the disclosure with a retractable work surface in a raised position.

### DETAILED DESCRIPTION

The present disclosure provides multi-purpose articles of furniture well suited for use as any of a variety of tables such as, but not limited to, a coffee table, a cocktail table, a living room table, an end table. The articles of the present disclosure may also function as a workstation or desk such as, but not limited to, a workstation for a portable computer. The articles of the present disclosure may also function as a storage and organization unit for work related items and supplies. In addition, the articles of the disclosure are aesthetically pleasing and thus may function as a design element in any room into which they are placed. The articles may be placed anywhere in a room such as, but not limited to, against a wall, in a corner, or “free-standing” away from any wall.

The articles of the present disclosure comprise a top surface divided inot at least two separate top surfaces positioned next to one another, one of which is movable enabling a user to position the movable top surface in a number of positions relative to himself. The articles of the present disclosure enable a user to access and operate a laptop computer and/or any peripheral placed on and/or within the article. The user may be seated on an article of furniture positioned near the article of the disclosure. The type of seating may be any furniture known in the art to be useful for sitting for example, but by no means limited to a chair, sofa, loveseat, setee, bench, stool, or an ottoman. The articles of the disclosure have at least two general configurations: a closed configuration and an open configuration. The terms “closed configuration” and “open configuration” are with respect to the at least one movable section of the article's top surface, discussed in further detail herein.

The articles of the present disclosure may comprise any one or more elements/features known in the art such as, but not limited to, drawers, shelves, doors, storage compartments, immobile top surface sections, movable top surface sections, power outlets/receptacles, phone jacks, data jacks, data ports, and computer ports. It is to be understood that articles of the disclosure may comprise any combination of any number of these elements/features. Generally the articles of the disclosure comprise at least one of each of these features. As known in the art, any one or more of these elements (with the exception of the immobile top surface section) may be mounted by use of hardware that enables the element to be positioned in more than one position. For example, any one or more drawers, shelves, doors, storage compartments, and top surface sections of the present articles may be mounted with guides/sliders thereby making them slidable/retractable.

With respect to size of the articles of the present disclosure, in one embodiment, the articles have a length between 12 and 120 inches. In another embodiment, the articles are of a length between 18 and 72 inches. In even another embodiment, the articles are of a length between 24 and 60 inches. In still another embodiment, the articles are of a length between 30 and 55 inches.

With respect to height, when in the closed configuration the articles are generally between 12 and 54 inches tall. In one embodiment, the articles are between 16 and 48 inches tall. In another embodiment the articles are between 18 and 40 inches tall. In even another embodiment the articles are between 20 and 24 inches tall.

With respect to depth, in one embodiment, the articles of the disclosure are of a depth between 12 and 60 inches. In another embodiment, the articles are of a depth between 18 and 48 inches. In even another embodiment, the articles are of a depth between 22 and 40 inches. In one non-limiting embodiment, the article has a length in the range of 46 to 50 inches, a height in the range of 20 to 24 inches, and a depth in the range of 28 to 30 inches. As used herein, the length describes the size of the article as measured from it's left end to it's right end; the height is the distance from the floor on which the article is sitting to the top of the top surface of the article; and the width or depth of the article is the distance from the front of the article's top surface (tabletop) to the back of the top surface (tabletop). All dimensions described herein are for articles are in a closed configuration unless indicated otherwise.

Generally the articles comprise a top surface panel, also referred to herein as a tabletop, supported by a base/body. The cross sectional shape of each of the base and top panel may be any shape such as but not limited to rectangular, square, oval, round, and any polygonal shape. A non-limiting embodiment having a base and a top panel each having a rectangular shaped cross section is illustrated in the present figures. In the non-limiting embodiment depicted in the present figures, the base comprises a left side/end panel, a right side/end panel, a back panel, a front, and a bottom panel. As used herein, terms such as “top”, “bottom”, “left”, “right”, “back” and “front” are from the perspective of an individual positioned in front of and facing the length of an article of the disclosure. Other embodiments entertain a body having a circular or oval cross sectional shape.

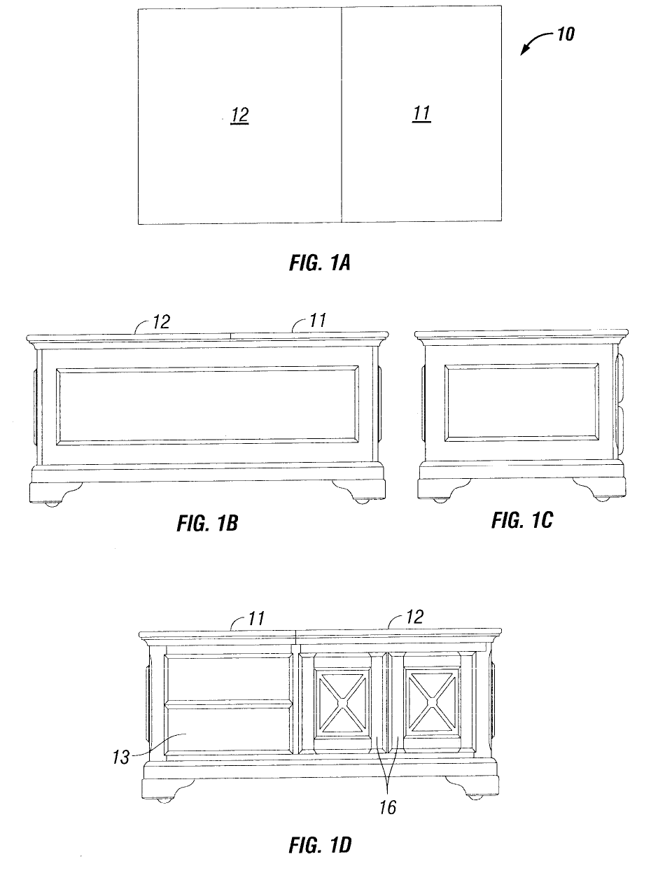

With respect to the top panel/tabletop of the articles of the disclosure, the top panel comprises at least two separate sections positioned beside one another: at least one immobile section fixed in position relative to the body/base, and at least one movable section which may be placed in more than one position relative to the body/base. The arrangement of the at least two distinct sections may be any arrangement, such as but not limited to, the immobile section may be the left portion of the top surface and the movable section may be the right portion of the top surface, or vice versa. FIG. 1A provides a top elevation view of the top panel of non-limiting article 10 having two distinct top surface panels/sections, wherein panel/section 11 on the right is a movable section, and panel/section 12 on the left is an immobile section. In other embodiments, the articles may have top surfaces comprising three or more separate/distinct top surface sections: a left, a right, and one or more center sections, wherein at least one section is an immobile section fixed in position, and at least one is a movable section. The arrangement of the three or more sections may be in any possible arrangement. For example an article may comprise a top surface having three distinct sections: a left, right and center section. The center section may be a movable section positioned between left and right immobile sections, or the center section may be an immobile section positioned between left and right movable sections.

While the figures of the present disclosure illustrate a rectangular shaped top panel, the top panel may have any shape including but not limited to rectangular, square, oval, round, triangular, and any regular or irregular geometric shape. In addition, the top panel is illustrated in the present figures as overhanging the front, back, left and right sides/ends when the article is in a closed configuration. As known by one of skill in the art, the top panel may overhang any one or more of the front, back, left and right sides/ends by any amount provided the article is in balance and maintains it's upright position. The articles may comprise a top surface that is flush with any one or more of the front, back, left and right sides/ends of the article when the article is in the closed configuration.

With respect to the sizes of the at least two top surface sections, the sections may be of approximately equal size relative to each another, or one section may be larger than the other section(s). Referring back to FIG. 1A, non-limiting article 10 comprises section 11 and section 12, wherein section 11 is less than one-half the entire surface area of the entire tabletop, and section 12 is more than one-half the entire surface area of the entire tabletop.

The movable top surface section may be mounted by any means known in the art that enables the section to be moved and placed in more than one position. The term “movable section” as used herein means the section may be moved and repositioned with respect to the immobile top section and the body of the article. The movable section may be mounted using a slide mechanism such that positioning and repositioning the section involves sliding it along a horizontal plane into any position/location within the functional range of the slide mechanism. A slidably mounted top section may be mounted to slide forward and backward, side to side, or both. Generally when mounted with a slide mechanism, the movable surface itself remains in a fixed horizontal position as it slides.

The movable section may be mounted to the body by a mechanism comprising any hardware known in the art such as but not limited to pivots, lifts, cantilevers, and any combinations thereof, such that positioning and repositioning the movable section involves lifting, raising, and/or protracting it away from the body of the article, and lowering or retracting it back toward the body of the article. The top section may be positioned at any point within the range of movement of the mounting mechanism. With respect to this variety of mounting mechanisms, the movable section may be mounted to the mechanism in a fixed position such that the section maintains a horizontal position as it is lifted away from the body of the table. Other embodiments entertain a movable top section mounted to a lift mechanism in an adjustable fashion thereby allowing the movable top section to positioned at an angle relative to the horizontal plane. Such an angle would be defined by and dependent upon any mounting hardware used to connect the movable top section to the mounting mechanism. Preferably the angle would not be so great that it affects the stability of any item placed on the movable top section.

As known to those of skill in the art, with respect to features of the present articles that are positionable at numerous positions along their path of movement, such features may comprise any means known in the art useful for temporarily securing the movable element in a desired position.

In one embodiment, the movable top surface section is mounted using heavy duty slides enabling a user to slide the movable section forward into an open configuration, and then back into the closed configuration. In another embodiment, the movable top surface section is mounted with a pivot link mechanism enabling a user to raise the movable section into an open configuration and lower the movable section back into the closed configuration.

The articles of the present disclosure may comprise one or more storage compartments. One or more of the storage compartments may be concealed and accessible by one or more doors. One or more storage compartments may also be concealed and accessible by the movable section of the top surface. Each storage compartment may be used to store and/or organize any one or more of a wide variety of items such as, but not limited to, a portable computer, computer-related items and supplies, work-related items and supplies, personal items, household items, and all combinations thereof. The one or more storage compartments may be any size and dimensions within the range of the dimensions of the article. Each of the one or more storage compartments may be mounted in an immobile, fixed position, or by one or more guides/slides that enable the compartment to function as a “pull-out” compartment. Suitable guides/slides for pull-out storage compartments include all such mechanisms known in the art such as but not limited to slides comprising wood, plastic, metal and all combinations thereof, for example, wood on wood guides, and ball-bearing slides. Guide/slide selection may be dependent upon at least the intended weight-bearing capacity of the storage compartment.

Each storage compartment may comprise one or more shelves. Each of the one or more shelves may be mounted in an immobile, fixed position, or by one or more guides/slides that enable the shelf to function as a “pull-out” shelf. Suitable guides/slides for pull-out shelves include all such mechanisms known in the art such as but not limited to slides comprising wood, polymer plastics, metal and all combinations thereof, for example, wood on wood guides, and ball-bearing slides. Guide/slide selection may be dependent upon at least the intended weight-bearing capacity of the shelf. For example, if it is desired that a shelf be capable of accommodating a heavy object, generally a heavy duty guide/slide is selected such as, but not limited to, a heavy duty ball-bearing slide. A pull-out shelf may enables a user to slide the shelf forward in order to facilitate the user's access to and/or use of the shelf, and/or items on the shelf. As known by one of skill in the art, the use of stoppers may be utilized if necessary to prevent the pull-out shelf from sliding completely off the guide/slide. For ease of mounting, generally the shelves utilized herein span the entire left to right distance of the storage compartment in which they are mounted.

With respect to the depth of the shelves, the depth of the shelf may be dependent upon the intended purpose of the shelf. For example, a shelf designed to store smaller items may only require a depth of 12 inches or less. A shelf intended to store one or more large items, for example, a printer, a scanner of similar, the shelf may be almost the full depth of the storage compartment in which the shelf mounted. With respect to the location of the shelf, the location may be depending upon the intended purpose of the shelf. Generally a shelf intended to hold a printer or scanner is mounted near the bottom of the storage compartment in which the shelf is mounted. A shelf intended to hold smaller items and supplies may be mounted at or above the lateral mid-point of the storage compartment in which the shelf is mounted.

Each of the one or more shelves, storage compartments, and/or storage areas may comprise a liner to protect and/or stabilize any items placed thereon. Suitable liners include all liners and materials known in the art. In one non-limiting embodiment, the liner is padded. In another non-limiting embodiment, the liner comprises neoprene. Generally the liner is applied to the surface of the shelf, storage compartment, and/or storage area upon which items may be placed and/or with which items may make contact. The shelves of the disclosure may comprise a rail or lip positioned at their outside edges to assist in preventing items from sliding off the shelf while being stored thereon.

As stated previously, each of the one or more storage compartments may be concealed and accessible by one or more doors. With respect to the one or more doors of the articles of the disclosure, the doors may be at any location provided the location allows for ease of operation and access to the doors. Thus, the one or more doors may be located on one or more of the following: an end panel, the back panel, the front, and any combination thereof. Generally, the one or more doors are located on the front panel. Each of the one or more of the doors may comprise a lock for security purposes. For simplicity and ease of operation, if an article of the disclosure comprises more than one lock, generally the locks are all keyed the same such that they are operable by a single key or a single combination. The locks utilized herein may be any suitable lock known in the art such as but not limited to a cam lock, a combination lock, cylinder lock. Generally the lock is located on and accessible from the front/face of the door.

With respect to the dimension of the doors, these are generally dependent at least upon the dimensions of the body of the article. The door may be any dimensions provided the door does not impede or physically hinder movement of the movable section of the article's top surface or any other feature of the article. The doors may be the maximally allowed height dimension based on the body of the article. With respect to the width of the doors, generally the doors are less than one-half of the length of the body of the article. In one embodiment, each door is less than one-third of the length of the body of the article. For doors present in a pair, each of the doors in the pair may or may not be of relatively equal dimensions to one another.

The doors may further comprise any features and/or hardware known in the art useful in facilitating the opening and the closing of a door such as, but not limited to, handles, recesses, knobs, clasps, door catches, locks, hinges, and all combinations thereof. As known by one of skill in the art, the doors may be mounted to the article in such a fashion that a user is able to open the doors then slide the doors into a compartment within the article and thus out of sight and out of the way.

The articles of the disclosure may comprise one or more drawers. The one or more drawers may be located at or on any part of the table that allows access to and utilization of the drawer. In one non-limiting embodiment, the one or more drawers are accessible from the front of the article. The one or more drawers may be located adjacent to the doors, and may be on the left side of the doors, the right side of the doors, or both. The one or more drawers may be located on the left or right end of the article and thus open to the left or the right, respectively. The one or more drawers may be used to store and/or organize any one or more of a wide variety of items such as, but not limited to, computer-related items and supplies, work-related items and supplies, personal items, household items, and all combinations thereof. The one or more drawers may be designed for specialized storage such as, but not limited to, designed to accommodate hanging letter and/or legal files. Any drawer slide mechanisms or “sliders” known in the art may be used herein including drawer sliders comprising wood, plastic, metal, and all combinations thereof. Selection of the type of drawer slider may be dependent upon at least the intended weight-bearing capacity of each drawer. For example, heavy-duty ball-bearing slides may be selected for mounting a drawer intended to store relatively heavy items, such as a file drawer for storing files.

Each of the one or more drawers may comprise a lock for security purposes. For simplicity and ease of operation, if an article of the disclosure comprises more than one lock, generally the locks are all keyed the same such that they are operable by a single key or a single combination. The locks utilized herein may be any type of lock suitable for use with articles of furniture such as but not limited to a cam lock, a combination lock, cylinder lock. For ease of operation, generally the lock is located on and accessible from the front/face of the drawer. Alternatively, in some embodiments the drawer lock may be located on and accessible from one of the sides of the drawer. Each drawer may comprise any type of handle, recess, notch, and/or knob useful in facilitating the opening and closing of the drawer. The depth and height dimensions of the drawer are dependent at least upon the dimensions of the body of the article. The drawer may be any dimensions provided it does not impede or physically hinder movement of the movable section of the article's top surface or any other feature of the article. To maximize the storage space provided by the drawer, the drawer may be the maximally allowed depth and height dimensions provided by the body of the article. Generally the depth of the drawer is in the range of at least one-fifth the depth of the article and the full depth of the article. With respect to the width of the drawer, generally the drawer is between one-fourth and one-half of the length of the body of the article. In embodiments comprising more than one drawer, the more than one drawers may be in any configuration including but not limited to side by side, stacked atop one another and any combination thereof.

The articles may further comprise feet, legs, casters, and any combinations thereof, attached to or extending from any part of the article. The feet and/or legs may be any style, length, and/or material known in the art. In one embodiment, the feet and/or casters are attached to the bottom panel of the body. The use of casters provide enhanced mobility and allow the table to be easily moved from one position/location to another. As known by one of skill in the art, locking casters may be utilized in order to prevent unintentional movement of the table. As also known by one of skill in the art, the casters may be hidden from view by use of any one or more design element known in the art including but not limited to trim and molding.

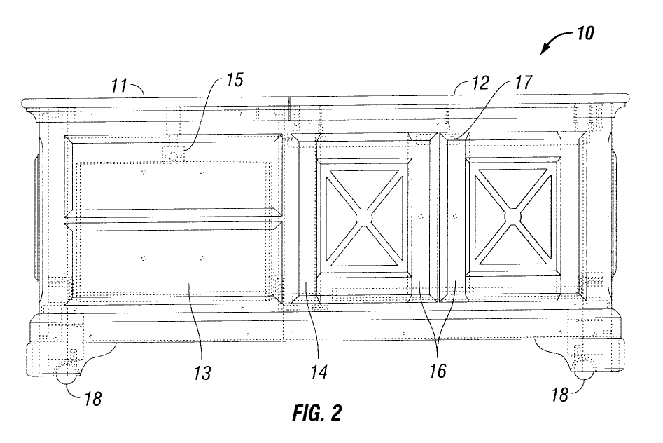

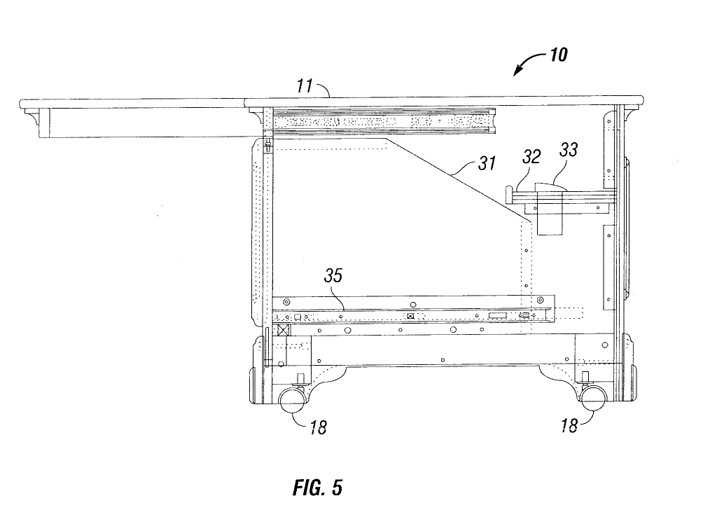

Referring now to FIGS. 1 through 6, there is illustrated non-limiting article 10 of the disclosure. In FIGS. 1 and 2, there are provided top (FIG. 1A), back (FIG. 1B), end (FIG. 1C) and front (FIG. 1D and FIG. 2) views of non-limiting article 10. The top surface of article 10 comprises two separate top surfaces or sections positioned beside one another: immobile section 11 and movable section 12. As discussed previously, although the top surface of article 10 comprises a fixed portion on the left (user's left when facing front of table) and a retractable portion on the right (user's right when facing front of table), it is within the scope of the present disclosure for the fixed portion to be on the right and the retractable portion to be on the left. As also discussed previously, articles of the disclosure may comprise one or more additional fixed or movable portions and the arrangement of the portions may be any possible arrangement. Movable section 12 may be mounted using a slide mechanism (not shown), thereby enabling a user to horizontally slide the section forward toward himself into an open configuration, and backward into the closed configuration. The slide mechanism may be a heavy duty slide. One preferred slide is a heavy duty ball-bearing slide. The mounting means for movable section 12 may be in mounted at any location of article 10 that provides proper position and function for movable section 12. For example, one slide cabinet member may be mounted to the interior of the right end panel and the other slide cabinet member may be mounted to an interior partition panel, and the sliding member of the slide may be attached to the underside of the top panel. Article 10 is depicted in a closed configuration in FIGS. 1-4, and in an open configuration in FIG. 5.

As shown by FIG. 1D and FIG. 2, article 10 further comprises drawer 13 and pair of doors 16 at it's front. Drawer 13 is housed below immobile top section 11, and between the left end panel and an interior panel (not shown). Drawer 13 may comprise any one or more design/aesthetic feature and/or element on it's face. Drawer 13 may comprise any one or more handles. The face of drawer 13 as illustrated in FIG. 1D and FIG. 2 has the appearance of being two stacked drawers despite it being a single drawer. As illustrated in FIG. 12, drawer 13 comprises drawer lock 15. Also shown in FIG. 2, article 10 further comprises magnetic door catches 17 which help maintain doors 16 in a closed position when the doors are closed and such a position is desired. Article 10 may further comprise four casters 18 attached to it's bottom as indicated in FIGS. 1-5 and 8.

Article 10 may further comprise slidable storage area 14. Storage area 14 may be used to store any one or more items. Storage area 14 is especially well-suited to store a portable computer, such as a laptop computer. Storage area 14 may be slidably mounted within article 10 by a drawer guide which enables storage area 14 to slide horizontally forward and backward for ease of access to items placed therein. As discussed previously, any guide/slide known in the art may be used for mounting the slidable components of the disclosure. One preferred guide for mounting slidable storage area 14 is a wood on wood drawer guide using a center mount. The interior bottom surface of storage area 14 may comprise a neoprene liner (not shown) in order to prevent damage to the one or more items placed and stored therein. The interior side surfaces of storage area 14 may also be lined with neoprene (not shown). While storage area 14 is depicted as being concealed behind the left door of pair of doors 16, it is within the scope of the present disclosure for storage compartment 14 to be directly accessible from the front of article 10 and not concealed by a door.

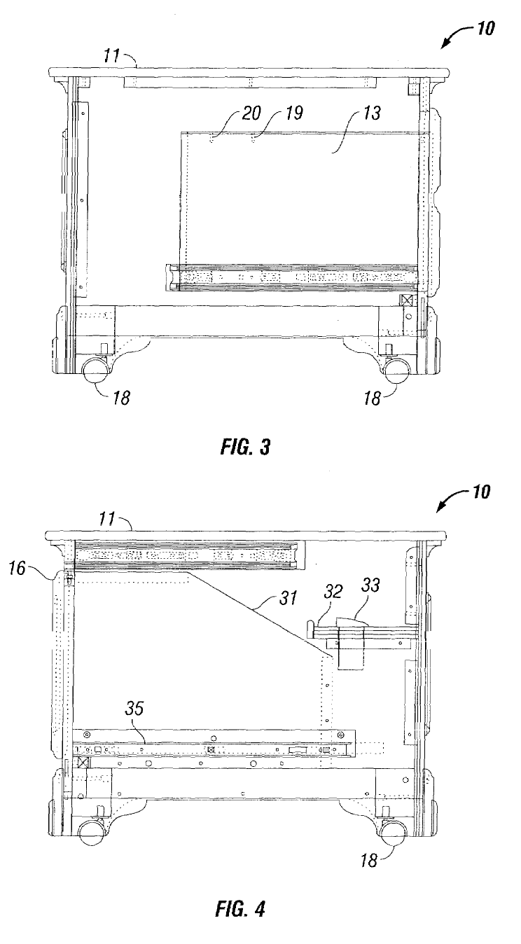

FIGS. 3 and 4 provide cross section right-hand end views of article 10. As can be seen in FIGS. 3 and 4, the upper rear right side portion of storage area 14 may comprise angled cut 31 thereby creating an open section at the upper rear portion of area 14 and simplifying access to any items stored therein. For example, angled cut 31 may enable access to a laptop computer for re-charging the laptop's batteries when it is stored in area 14. As seen in FIG. 3, drawer 13 may comprise grooves 19 and 20 for accommodating file bars used for hanging different types of files such as but not limited to letter-sized files (groove 19) and legal-sized files (groove 20). Thus drawer 13 may function as a file drawer.

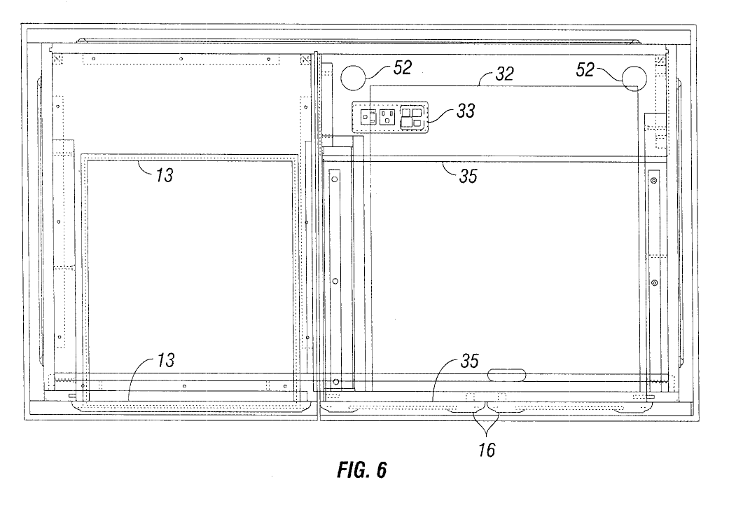

Pair of doors 16 conceal a storage compartment defined by movable top section 12 (when section 12 is in the closed configuration), the right end panel, an interior panel (not shown) and the bottom panel. The storage compartment may comprise horizontally slidable shelf 35, shown in FIGS. 4-6. (FIGS. 4 and 5 each provide a cross section plan view of article 10, and FIG. 6 provides a cross section view of storage tray 32.) Slidable shelf 35 may be located below movable work surface 12. Slidable shelf 35 may be slidably mounted and as such a user may horizontally slide shelf 35 forward from a retracted position (shown) to facilitate access to the shelf and any item stored thereon. Slidable shelf 35 may be slidably mounted by a set of heavy duty ball-bearing slides (not shown). The slides may be side mounted for example, one slide cabinet member of the set of slides may be mounted to the inner surface of the right hand end panel and the other slide cabinet member may be mounted to the interior panel.

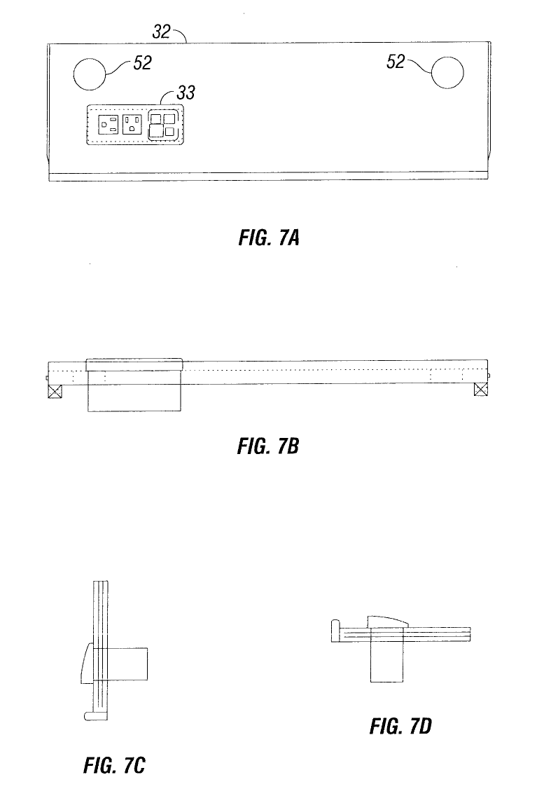

The storage compartment located behind pair of doors 16 may further comprise storage shelf/tray 32, shown in FIGS. 4-6. As shown in FIGS. 4 and 5, the storage compartment comprising slidable shelf 35 and storage tray 32 may be accessed by either opening doors 16 or by sliding movable top section 11 to a forward/open configuration. Tray 32 may comprise power and data port 33, also shown in FIGS. 4-6 and featured in FIG. 7. (FIGS. 7A and 7B provide top and front views, respectively, of tray 32 and port 33, and FIGS. 7C and 7D provide respective side views of 7A and 7B.) Port 33 generally comprises surge protection and may comprise any one or more of power outlets, a telephone jack such as an RJ11 telephone jack, a data jack such as an RJ45 data jack, and a computer port such as a USB port, and may be used to power and/or charge electronic computer peripherals. Port 33 may be any port known in the art. One example of a suitable port is the FC-620/LP3000 manufactured by Furnlite Inc. The unit comprise electrical receptacles, telephone, data and USB ports on two of it's four faces/sides.

Tray 32 may be used to organize and/or store any items such as but not limited to computer and electronic peripherals. The items may be any one or more electronic device such as, but not limited to, laptop computers, camera docking stations, cell phones, iPods, MP3 players, PDA's, and BlackBerry devices. For example, a laptop computer may be placed on tray 32 and may be charged by use of port 33. By placing the item on tray 32 while it is being charged instead of placing it on either of top sections 11 and 12, article 10 may be given an uncluttered appearance, and top sections 11 and 12 made available for other use. As shown in FIGS. 6 and 7, tray 32 may comprise holes 52 (two are shown) with grommets for wire management. The holes may be at any location on tray 32 so long as their location is suitable for wire management. FIGS. 6 and 7 show one hole at each end of tray 32. Storage tray 32 may be mounted by attachment to the inside surfaces of the surrounding vertical end panels and/or the back panel. As shown in FIGS. 7C and 7D, tray 32 may comprise a vertical rail or lip attached on the outside edge to prevent peripherals from sliding off the shelf while stored thereon.

FIG. 5 provides a cross section right-hand end view of article 10 in an open configuration wherein movable top section 11 has been moved forward in the direction of the front of article 10. When movable top surface section 11 is in an open/extended position, tray 32 and port 33 are accessible from above. With respect to the movable top surface sections of the articles of the disclosure, the ability to slide this top section forward in a horizontal plane allows an individual to position the surface at a number of positions relative to himself. Also, the ability to slide the work surface forward eliminates the need for an individual to remove any objects placed on top of surface 11 in order to access any interior feature such as, but not limited to, shelf 35 or tray 32, located underneath the movable surface 11.

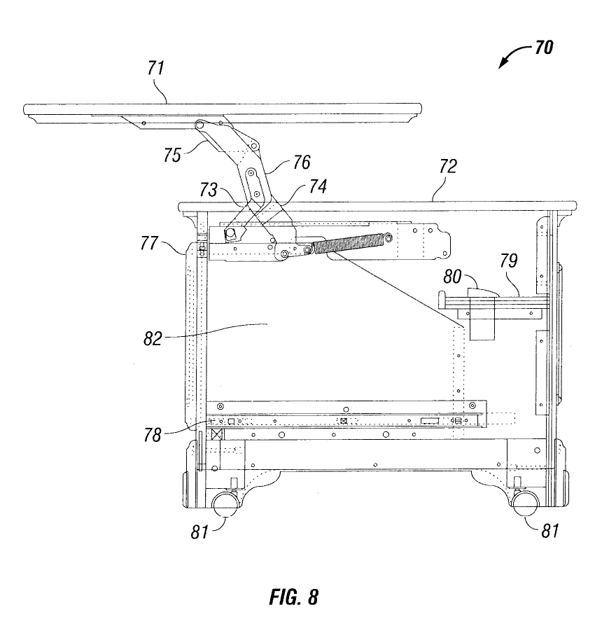

Referring now to FIG. 8, there is shown a cross section right-hand end view of non-limiting article 70 of the disclosure. Article 70 comprises movable top surface section 71, and immobile top surface section 72. Article 70 is depicted in an open/extended configuration in FIG. 8. In the embodiment depicted in FIG. 8, movable top surface 71 is upwardly protractable and downwardly retractable, and is movable between open configurations (one of which is shown) and a closed configuration (resembling the closed configuration of article 10 depicted in FIGS. 1 through 4). The path of movement of top section 71 from the closed to a fully open configuration is generally determined by the mounting mechanism used to connect said movable top section with the mounting mechanism and/or with the body of the article. Generally the mounting mechanism may be mounted to the base and to the movable top section, and may also be configured such that it mounts to one or more end panel, preferably on the interior of such an end panel. The non-limiting mechanism illustrated in FIG. 8 comprises front pivot link 73, pivotally interconnected to the base at a first pivot, and rear pivot link 74 pivotally interconnected to the base at a second pivot link, and is mounted to movable top section 71 at the upper portion of front pivot link 75 at a third pivot, and at the upper portion of rear pivot link 76 at a fourth pivot.

Article 70 may comprise any one or more features known in the art including those described for article 10. Shown in FIG. 8 are door 77, slidable shelf 78, storage tray 79, port 80, casters 81, and slidable storage area 82, all of which are similar to corresponding elements described previously for article 10. As illustrated in the present figures, article 10 of FIGS. 1-5 and article 70 may differ only in the manner in which their respective movable top surface sections move. For example, whereas article 10 is shown as comprising a horizontally slidable top surface section, article 70 comprises an upwardly protractable top surface section.

As discussed previously, it is within the scope of the present disclosure for an article to comprise at least three top surface sections wherein at least one section is immobile and at least one section is movable. For an embodiment comprising two movable sections, the two movable sections may be mounted using similar or different hardware from one another. For example, one movable section may be mounted with a slide-type mechanism and thus movable similar to top section 11 of FIGS. 1-5, and the second movable section may be mounted with a lift or pivot type mechanism and movable similar to top section 71 of FIG. 8.

Each of the exterior and interior surfaces of the tables of the present disclosure may comprise any one or more protective and/or decorative finishes and/or treatments known in the art including stain, paint, varnish, polyurethane, wax, oils, and any combinations thereof. With respect to paint finishes, the paint may be applied using any technique known in the art, such as but not limited to, application of paint to result in an aged and/or distressed look. The tables of the disclosure may comprise any decorative features, elements, techniques, and/or designs known in the art including trim, hardware, inlay, etching, routed surfaces and/or edges, marquetry, parquetry, and all combinations thereof. With respect to the material from which the tables of the disclosure are manufactured, any one or more materials known in the art may be used including solid wood material, wood composite material, plywood materials, composites, polymers, ceramics, metals, and all combinations thereof. The wood may be any hardwood or softwood known in the art including, but not limited to, ash, beech birch, cherry, hickory, maple, oak, poplar, walnut, fir, and pine. Assembly of the articles may comprise any joinery and wood joinery methods, any type of hardware, glue compounds, and all combinations thereof, and the use of any methods known in the art for assembling furniture.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

All references cited herein, including articles, U.S. and foreign patents and patent applications, are specifically and entirely incorporated herein by reference.

What is claimed is:

1. An apparatus comprising:
a tabletop and a base, wherein said tabletop and said base define an interior compartment, wherein said tabletop is positioned in a horizontal plane and supported by said base, wherein said tabletop comprises at least first and second tabletop sections positioned adjacent one another, wherein said first tabletop section is immobile with respect to said base, and said second tabletop section is movable with respect to said base, and wherein said second tabletop section is movable within said horizontal plane.

2. The apparatus of claim 1 wherein each tabletop section comprises at least one-fourth of the surface area of the tabletop.

3. The apparatus of claim 1 wherein said base comprises a front panel, a back panel, a left end panel, a right end panel, and a bottom panel.

4. The apparatus of claim 2 wherein said base has a square or rectangular cross section.

5. The apparatus of claim 2 wherein said base further comprises an interior partition panel extending vertically from said bottom panel to said tabletop, wherein said partition panel divides said interior compartment into first and second sub-compartments, wherein said first sub-compartment is located below said first tabletop section, and said second sub-compartments is located below said second tabletop section, and wherein said second sub-compartment is accessible by moving said second tabletop section.

6. The apparatus of claim 5 wherein said first sub-compartment houses a drawer.

7. The apparatus of claim 6 wherein said front panel comprises a pair of doors, wherein said second sub-compartment is accessible by opening said doors.

8. The apparatus of claim 7 wherein said second sub-compartment comprises a port comprising at least one element selected from the group consisting of power outlets, telephone jacks, data jacks, computer ports, and any combinations thereof.

9. The apparatus of claim 8 wherein said second compartment further comprises at least one shelf mounted therein.

10. The apparatus of claim 9 wherein said second compartment comprises at least one sliding shelf which may be moved in the horizontal plane.

11. The apparatus of claim 1 wherein said apparatus has a height dimension in the range of 12 to 54 inches, a length dimension in the range of 12 to 120 inches, and a depth dimension in the range of 12 to 60 inches.

12. The apparatus of claim 1 further comprising casters affixed to the underside of said bottom panel.

13. An apparatus comprising:
a tabletop and a base, wherein said tabletop and said base define an interior compartment, wherein said tabletop is supported by said base, wherein said tabletop comprises at least first and second tabletop sections positioned adjacent one another, wherein said first tabletop section is immobile with respect to said base, and said second tabletop section is movable with respect to said base, and wherein said second tabletop section is movable by raising said section away from said base.

14. The apparatus of claim 13 wherein each tabletop section comprises at least one-fourth of the surface area of the tabletop.

15. The apparatus of claim 13 wherein said base comprises a front panel, a back panel, a left end panel, a right end panel, and a bottom panel.

16. The apparatus of claim 14 wherein said base has a square or rectangular cross section.

17. The apparatus of claim 14 wherein said base further comprises an interior partition panel extending vertically from said bottom panel to said tabletop, wherein said partition panel divides said interior compartment into first and second sub-compartments, wherein said first sub-compartment is located below said first tabletop section, and said second sub-compartments is located below said second tabletop section, and wherein said second sub-compartment is accessible by moving said second tabletop section.

18. The apparatus of claim 17 wherein said first sub-compartment houses a drawer.

19. The apparatus of claim 18 wherein said front panel comprises a pair of doors, wherein said second sub-compartment is accessible by opening said doors.

20. The apparatus of claim 19 wherein said second sub-compartment comprises a port comprising at least one element selected from the group consisting of power outlets, telephone jacks, data jacks, computer ports, and any combinations thereof.

21. The apparatus of claim 20 wherein said second compartment further comprises at least one shelf mounted therein.

22. The apparatus of claim 21 wherein said second compartment comprises at least one sliding shelf which may be moved in the horizontal plane.

23. The apparatus of claim 13 wherein said apparatus has a height dimension in the range of 12 to 54 inches, a length dimension in the range of 12 to 120 inches, and a depth dimension in the range of 12 to 60 inches.

24. The apparatus of claim 13 further comprising casters affixed to the underside of said bottom panel.
